(19) United States
(12) Patent Application Publication
(10) Pub. No.: US 2014/0117672 A1
(43) Pub. Date: May 1, 2014

(54) TIDAL MOTOR

(71) Applicant: Daniel Therriault, Jackman, ME (US)

(72) Inventors: Daniel Therriault, Bishopton (CA); Georges Beauregard, Granby (CA); John P. Kuchta, JR., Virginia Beach, VA (US)

(21) Appl. No.: 13/922,407

(22) Filed: Jun. 20, 2013

(30) Foreign Application Priority Data
Oct. 26, 2012 (CA) 2793716

(51) Int. Cl. F03B 13/26

(52) U.S. Cl. CPC F03B 13/26
USPC 290/53

(57) ABSTRACT

A tidal motor system comprises a horizontal floating platform subjected to a vertical movement due to the tides. The platform is preferably in a circular shape in order to minimize friction, and in combination with a hub located in the center and extending upwardly and comprising angle pitch. A dome located above high tide comprises a meshing device with opposite angle pitch to receive the hub. When the hub is rising (or descending) because of a rising (or a descending) tide, the extension of the hub working as a drive shaft engages a first gear provided with a meshing female, and the first gear commands a number of meshing intermediate gears wherein the last gear drives a generator or suitable mechanical device. The gears are enclosed in a dome fastened in combination with vertical beams anchored in the ground to ensure the stability of the system.

### BACKGROUND OF THE INVENTION

The present invention relates to the field of marine mechanics, more particularly to the power production from the ebb and flow of tides.

### PRIOR ART

The present invention refers to a previous Canadian patent CA 2793716 <<Tidal motor>> filed on Oct. 26, 2012 by two of the same authors which show a tidal motor comprising a number of generators mounted on a floating platform installed in combination with vertical beams provided with means of rack such that the pinions of the generators drive along the rack beams. The tide pulls the platform which causes the rotation of the pinions along the rack beams. The rotation of the pinions drives the generators which produce electricity. The shaft of the pinions can be mounted in combination with a number of gears to multiply the produced velocity and energy.

In the present invention the floating platform has preferably a circular shape and comprises a hub located in the center, the hub extends upwardly in a vertical shaft comprising angle pitch. The other end of the shaft activates means of gears comprising a meshing female with opposite angle pitch to receive the shaft. The gears activate a generator or suitable mechanical device. The gears are enclosed within a dome which is fastened in combination with vertical pillars anchored in the ground which assure its stability, and the stability of the whole motor because the dome and the platform are in combination together through the drive shaft.

### OBJECTIVES AND ADVANTAGES

Tides are created by the moon attraction and generate a great power; nothing can prevent the tide from lifting or raising a mass. This power is used to lift or descend a floating platform having an upstanding shaft which turns gears which drive a generator (or suitable mechanical device).

There is a need on the market for a tidal motor producing energy with a minimum of interventions, and at any time of the tide: rising tide, low tide, even a stagnant tide.

Our tidal motor comprises a combination of the following elements:

A floating platform in a circular shape having a hub in the center, the hub may rotate due to the tide movement but it is essentially positioned to hold an upstanding shaft which is displaced by the rise and lowering of the platform, the displacement thereof being transferred to gears which rotate and activate a generator or a mechanical device. The platform may be of typically 60-75 ft in diameter and 35 ft of height.

The hub extends upwardly in a vertical shaft comprising angle pitch. The hub is being pushed upward or downward due to the tide rising or descending, an extension of the hub working as a drive shaft.

A number of intermeshed gears being commanded by the shaft, with a last gear activating a generator or suitable mechanical device. Gears are placed inside a dome.

Vertical pillars support the dome containing the gears to ensure stability for the whole assembly.

The platform could be fixed directly to the gears without using the shaft: the hub is so directly linked through the dome, precisely to a first gear which will rotate while the shaft engages it for rotating by means of its angled pitch. And the first gear turns a number of intermeshed intermediate gears.

The platform can be provided with means of pumps which suck up and propel water towards a turbine at a necessary pressure for the turbine to command a generator or suitable mechanical device. The pump may be commanded by the displacement of the platform. A system of pipes gets back the water of the turbine for the re-use.

The present invention will be further understood from the following description with reference to the drawings.

### BRIEF DESCRIPTION OF DRAWING FIGURES

FIG. 1 is a perspective view of the tidal motor with a doughnut-shape floating.

FIG. 2 is a perspective view of the hub having a keyway.

FIG. 3 is a perspective view of Intermeshed gears.

FIGS. 4A and 4B are front view of opposites angles pitches causing rotation,

FIG. 5 is a perspective view of the tidal motor with a circular-shape floating.

### DETAILED DESCRIPTION OF THE PREFERRED EMBODIMENTS

In the following description and in the accompanying drawings, the numeral numbers refer to identical parts in the various Figures.

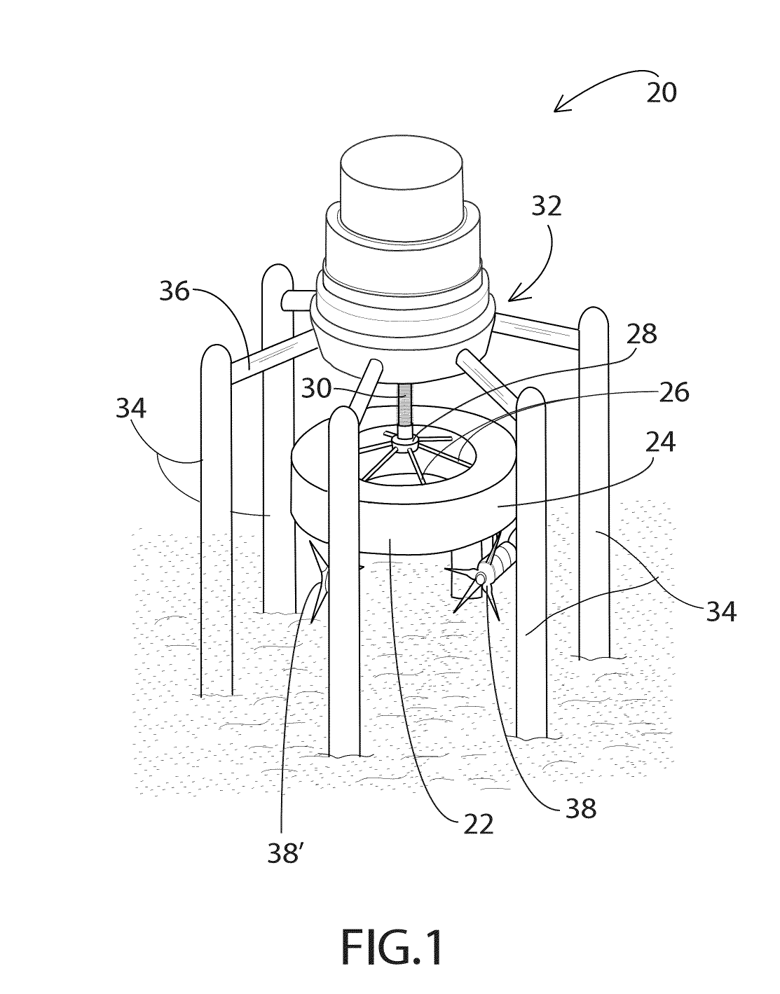

FIG. 1 shows a tidal motor system comprising a floating platform 22 in a doughnut-shape 24 with rays 26 converging towards a center hub 28 which may rotate (or not) due to the tides movement. When rising (or descending) the hub initiates revolution of a large enclosed gear (not shown here) located inside a dome 32. The hub supports a vertical threaded shaft 30 commanding the gears located inside a dome 32. The dome is supported by vertical pillars 34 through members 36. Helixes 38 fixed at the bottom of the platform are used to accentuate the rising or descending movement.

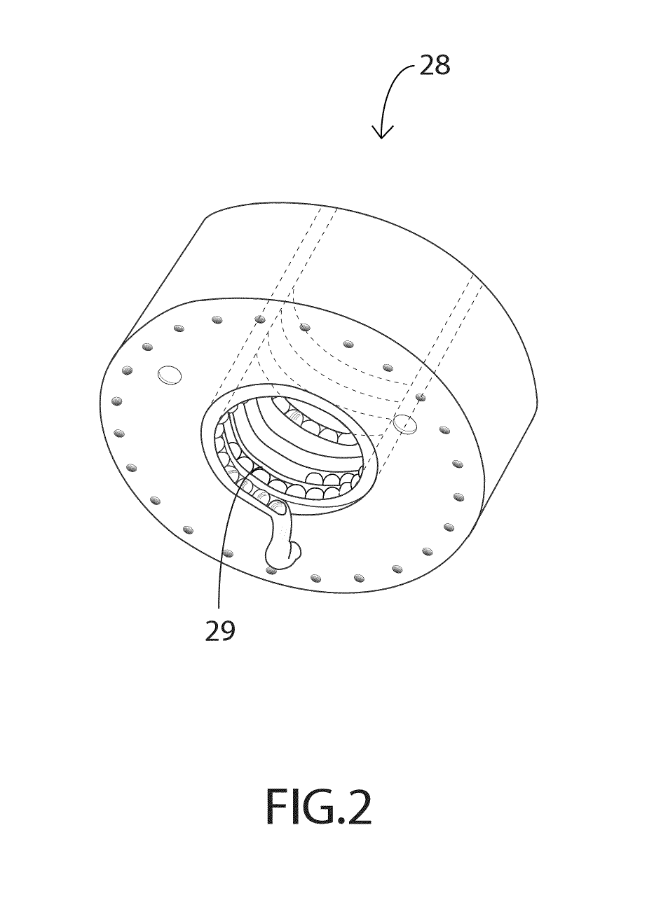

FIG. 2 shows a widened view of the hub 28 supporting the threaded shaft and having a keyway 29.

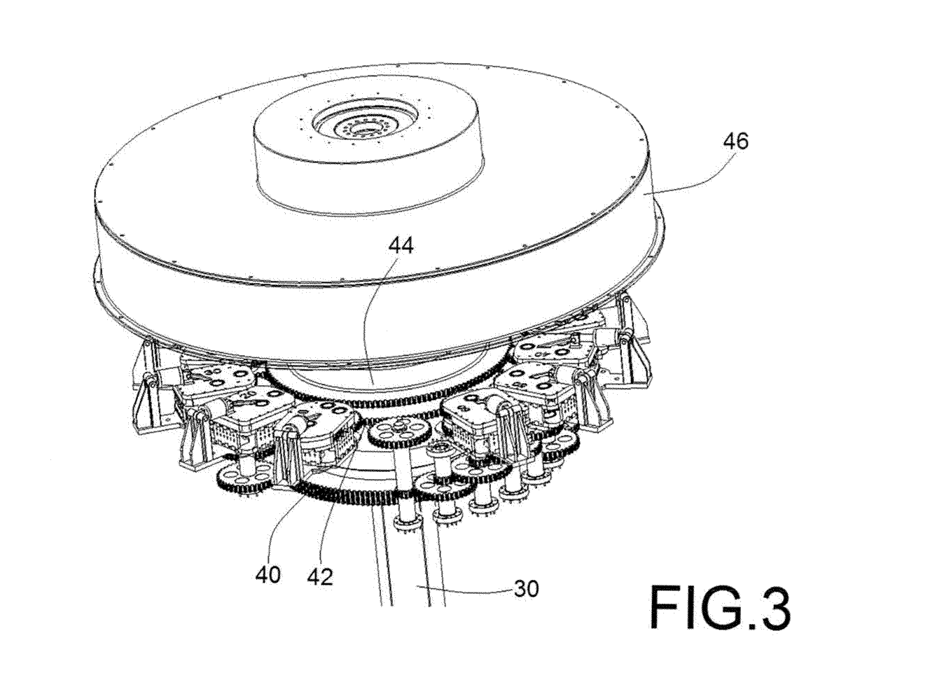

FIG. 3 shows the threaded shaft 30 driving a first gear 40 which drives an intermediate gear 42 which drives a generator gear 44. The generator 46 is also shown.

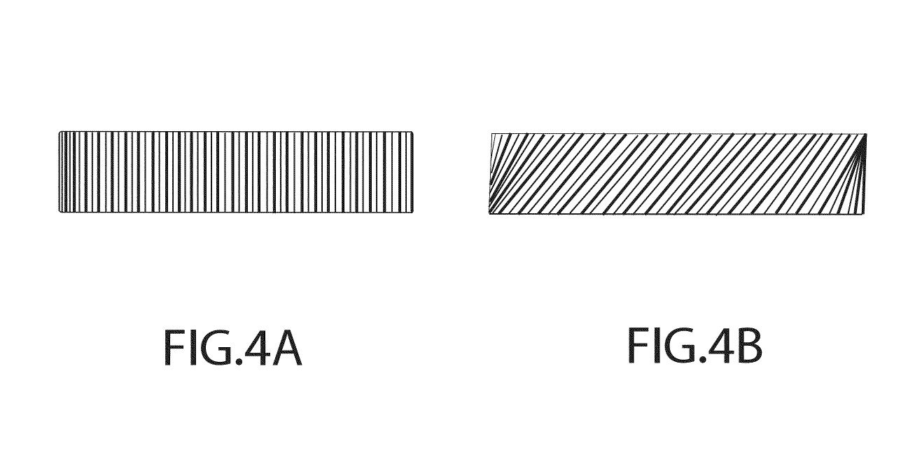

FIG. 4A and FIG. 4B show front views of opposite angle pitches adapted to mesh one another and to initiate a rotational movement.

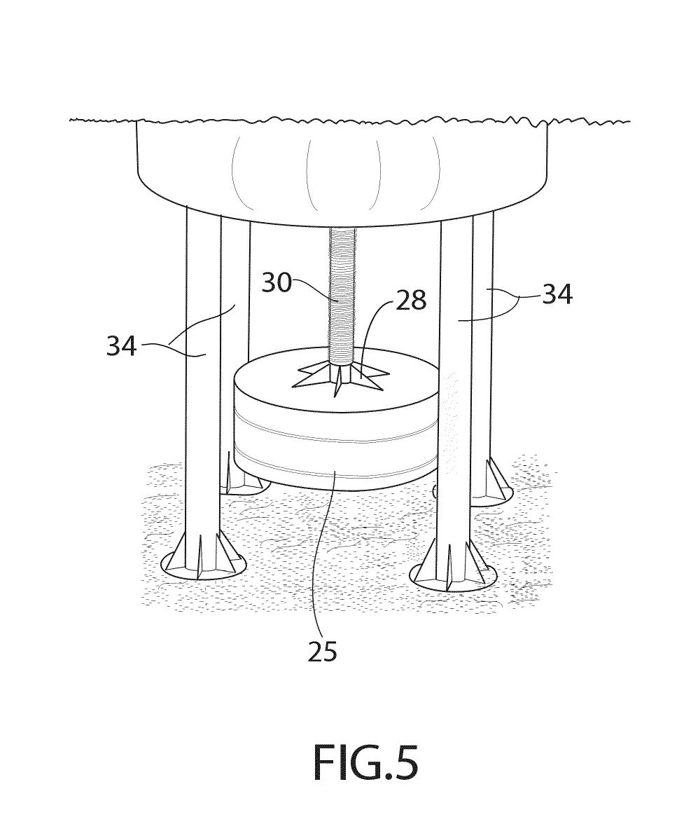

FIG. 5 shows a circular-shaped 25 floating platform having a hub 28 in the center with a threaded shaft 30. A dome, containing gears, is shown above the platform, supported by pillars 34.

### Calculation of Produced Power

A mass of weight equal to the displaced water times the displacement is a measure of energy in ft-lb: for a vessel of approximate dimensions of 65 ft diameter by 55 ft height, the weight is (55×65×65×π/4) cu.ft at 62.4 lb per cu.ft gives 11 382 65 ft-lb.

This energy may be applied over a period of time more or less rapidly, and depending on means of concentration of the weight, for example for priming a hydraulic pump.

The upward displacement may be made with an empty vessel which may be filled at high tide and be full upon descending, the weight of the full vessel causing the rotation of the gears with the same energy output.

In another case the vessel may be filled to reach a low point at the bottom of the course and emptied before reaching a high position at the top, the purpose being for a maximum course. The travel of the vertical shaft comprises the height of the rise of the tide plus the difference in height of a full and an empty vessel. Means of emptying the vessel is applied at end of low tide, and means of filling when at high tide. Those means of emptying and filling may include ballasts, closeable apertures or pumps which empty or fill those ballasts.

### SUMMARY

A tidal motor comprising a combination of a floating platform subject to a vertical movement due to the rise or the descent of the tide, with a means of hub located in the center of the platform, the hub extends upwardly and comprises angle pitch, extension thereof works as a threaded shaft, and with a dome comprising a master gear with an opposite angle pitch adapted to mesh with the shaft. The master gear is driving a generator or suitable mechanical device.

The master gear could drive a number of intermediate intermeshed gears located inside the dome, wherein a last gear of the intermediate gears drives the generator (or suitable mechanical device).

There is any number of intermediate intermeshed gears.

The dome is anchored in the ground by vertical pillars.

The platform may comprise means of helixes fixed at the bottom to accentuate the movement and make turn the shaft more easily.

To minimize friction a circular shape of the platform is preferred.

A doughnut-shaped platform is shown in FIG. 1; the platform comprises rays converging towards a hub placed in the center of the doughnut. Inside the hub a keyway allows a vertical axle to rotate and to be pulled upward or downward according to the rise or the descent of the floating platform according to the rise or the descent of the tide. The other end of the axle activates means of intermeshed gears enclosed in the dome, with a last gear commanding a generator.

One can say that the platform may work as a vessel and the vertical shaft is a mast fixed thereto; the vessel may comprise means of filling at high tide for meshing with the opposite angle pitch while descending. The vertical displacement of the vertical shaft comprises a height of the rise of the tide plus the difference in height between a full and an empty vessel.

Means of emptying the vessel may also be used for creating floating while at low tide. Those means of filling and emptying may comprise ballasts filled/emptied with pumps or with closeable apertures.

Those means of filling can also made by a combination of pumps, turbines and pipes, commanded by the displacement of the platform, such that the pumps suck tip and propel water towards a turbine at a necessary pressure for the turbine to drive a generator gear. A network of pipes gets back the water of the turbine under the platform for a re-use.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the appended claims.

### PARTS

20 Tidal motor system

22 Floating platform

24 Doughnut-shaped floating platform

25 Circular-shaped floating platform

26 Rays

28 Flub

29 Keyway

30 Threaded shaft

32 Dome comprising intermeshed gears

34 Vertical beams or pillars

36 Support members of the dome on the pillars

38-38′ Helixes

40 First gear

42 Intermediate gear

44 Generator gear

46 Generator

I claim:

1. A tidal motor comprising a combination of:
a floating platform subject to a vertical movement due to a rise or a descent of a tide;
a means of hub located in the center of said platform;:
a vertical threaded shaft springing from said hub and extending upwardly and comprising angle pitch;
a dome comprising a master gear with an opposite angle pitch adapted to mesh with said shaft, said master gear adapted to power a mechanical device;
said dome is anchored in the ground by vertical pillars.

2. The tidal motor of claim 1 wherein said master gear drives a number of intermeshed gears and comprises a last gear driving said mechanical device.

3. The tidal motor of claim 1 wherein said mechanical device is a generator.

4. The tidal motor of claim 1 wherein said platform is in a circular shape to minimize friction.

5. The tidal motor of claim 1 wherein said hub comprises a keyway allowing said shaft to rotate easily.

6. The tidal motor of claim 1 wherein said platform comprises means of helixes to accentuate said movement of said platform.

7. The tidal motor of claim 1 wherein said platform is a vessel and said vertical shaft is a mast fixed thereto, said vessel comprising means of filling at high tide for meshing with said opposite angle pitch while descending.

8. The tidal motor of claim 7 wherein a vertical displacement of said vertical shaft comprises a height of the rise of the tide plus the difference in height between a full and an empty vessel.

9. The tidal motor of claim 7 comprising means of emptying for creating floating, while at low tide.

10. The tidal motor of claim 9 wherein said means of emptying comprise ballasts and pumps.

11. The tidal motor of claim 7 wherein said means of filling comprise ballasts and pumps.

12. The tidal motor of claim 7 wherein said means of filling comprise means of pumps, said pumps suck up and propel water towards said turbines at a pressure
for said turbines to drive said mechanical device.
